(19) United States
(12) Patent Application Publication
(10) Pub. No.: US 2009/0252468 A1
(43) Pub. Date: Oct. 8, 2009

(54) Optical fiber preform including a non-axisymmetric cross section

(75) Inventors: Ryuichi Sugizaki, Chiyoda-ku (JP); Akifumi Sako, Chiyoda-ku (JP); Takeshi Yagi, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: The Furukawa Electric Co, Ltd., Chiyoda-ku (JP)

(21) Appl. No.: 11/500,958

(22) Filed: Aug. 9, 2006

Related U.S. Application Data
(63) Continuation of application No. PCT/JP06/05483, filed on Mar. 14, 2006.

(30) Foreign Application Priority Data
Apr. 26, 2005 (JP) 2005-127905

(51) Int. Cl. G02B 6/02; C03B 37/028; C03B 37/012

(52) U.S. Cl. 385/123; 65/412; 65/385

(57) ABSTRACT

A method for manufacturing an optical fiber includes the steps of covering an outer periphery of a first glass (11) having a first softening temperature and a non-axisymmetric structure by a second glass (12, 13) having a second softening temperature which is lower than the first softening temperature, heating the first and second glasses (11, 12, 13) for fusion together to thereby obtain an optical fiber preform; and drawing the preform to the optical fiber.

### TECHNICAL FIELD

The present invention relates to an optical fiber preform and a method for manufacturing the optical fiber preform, and more particularly, to an optical fiber preform used for manufacturing an optical fiber for use in a relatively short distance transmission.

### BACKGROUND ART

It is known that an optical fiber including OH radicals has a large absorption peak in the vicinity wavelength of 1380 nm. To prevent the occurring of such an absorption peak, a technique is generally employed wherein the portion of the optical fiber through which the light passes is totally synthesized so as to have less OH radicals. Examples of the total synthesis technique include vapour-phase axial deposition (VAD), outside vapour deposition (OVD) and modified chemical vapour deposition (MCVD).

In general, since the light transmits in an axial symmetry, the optical fiber is manufactured to have an axisymmetric structure by paying the full attention on the circularity of a core of the optical fiber. In addition, the axisymmetric structure is the most desirable structure to manufacture the optical fiber. Accordingly, although some optical fiber, such as a polarization-maintaining optical fiber, may have a non-axisymmetric structure of a stress-applying part other than the core, even the stress-applying part of the most of the polarization-maintaining optical fibers is generally formed to have the axisymmetric structure.

Techniques for manufacturing the optical fiber preform include a rot-in-tube (RIT) technique in addition to the total synthesis technique. The RIT technique is such that the glass rod including the core and manufactured by the total synthesis technique is inserted into a glass tube, and the glass tube and the glass rod are collapsed by heating to form an optical fiber preform. The techniques further include a rot-in-cylinder (RIC) technique wherein the collapsing the glass tube and the glass rod by heating is conducted concurrently with the drawing step.

Since the required characteristics of the optical fiber are being complicated in these days, a variety of optical fibers corresponding to these requirements are proposed. The optical fibers proposed heretofore include a non-axisymmetric optical fiber and a photonic-crystal optical fiber, the latter having a plurality of air holes in the cladding section of the optical fiber. Patent Publication JP-2003-342031A describes a preform for the photonic-crystal optical fiber and a method for manufacturing the same. It is recited in the publication that the optical fiber preform is manufactured by assembling and fusing a plurality of non-axisymmetric glass rods.

### DISCLOSURE OF THE INVENTION

### Problems to be Solved by the Invention

The optical fiber is now being used as an interconnection in an optical circuit. This technique can utilize the high-speed characteristic of the optical signal. In addition, the up-to-date optical circuit now uses a vertical-cavity surface-emitting laser (VCSEL) device, which has not been used heretofore in a long-distance optical communication system. Suppose a case wherein the light emitted from a luminous object such as the VCSEL device is directly transmitted through an optical fiber. If the optical fiber includes a core having a specific shape corresponding to the light-intensity distribution of the luminous object such as a star-shaped or polygonal distribution, for example, an extremely efficient light transmission can be achieved.

In order for manufacturing a preform including a core, or stress-applying section, having an arbitrary shape, such as a star or polygonal shape, it is generally necessary to prevent deformation of the core shape and thereby maintain the precise shape of the core during the heat treating. In the total synthesis technique as described above, however, it is difficult to form a preform having such an arbitrary shape of the core. Thus, the arbitrary shape of the core is generally obtained by assembling and fusing together a plurality of glass members each having a specific shape corresponding to a portion of the arbitrary shape.

For example, the polarization-maintaining optical fiber is known as such obtained by assembling and fusing together a plurality of glass members. The technique is such that a plurality of holes each having a specific shape are formed in a preform, and respective glass members, or cylindrical glass rods, which are shaped beforehand to have a small diameter, are inserted in the holes. In this technique, it is generally difficult to obtain a desired shape with a precise dimensional accuracy, particularly in a process for forming an axisymmetric shape which is liable to deformation during the fusing step.

In view of the above, it is an object of the present invention to provide an optical fiber having a non-axisymmetric structure, which is suited for use in direct transmission of a video image or photographic image, for example.

It is another object of the present invention to provide a method for manufacturing an optical fiber having an arbitrary shape with a precise dimensional accuracy, and to provide a preform used in the method.

### Means for Solving the Problems

The present invention provides, in a first aspect thereof, a method for manufacturing a preform including the steps of: covering an outer periphery of a first glass having a single first softening temperature by a second glass having a single second softening temperature which is lower than the first softening temperature; and heating the first and second glasses up to a heating temperature for fusion, thereby forming an integral body of the first and second glasses.

The present invention provides, in a second aspect thereof, a method for manufacturing an optical fiber including the steps of: covering an outer periphery of a first glass having a single first softening temperature by a second glass having a single second softening temperature which is lower than the first softening temperature; inserting an assembly of the first and second glasses in a glass tube; and collapsing said glass tube and said assembly of said first and second glasses by heating at the same time of drawing the optical fiber.

The present invention provides, in a third aspect thereof, an optical fiber preform including a plurality of glasses including first and second glasses, wherein the first glass configures a central core section and has a non-axisymmetric structure, the second glass configures a cladding section covering an outer periphery of the first glass, and the first glass has a softening temperature higher than a softening temperature of the second glass.

The present invention provides, in a fourth aspect thereof, an optical fiber manufactured by drawing the optical fiber preform of the present invention.

### EFFECTS OF THE INVENTION

The method of the present invention has an advantage over the prior art that an optical fiber having a desired shape can be manufactured from the preform wherein the outer periphery of the first glass having the first softening temperature is covered with the second glass having the second softening temperature lower than the first softening temperature.

According to the optical fiber preform of the present invention, an optical fiber including a core having a non-axisymmetric structure with a higher dimensional accuracy can be obtained from the optical fiber preform because the second glass configuring the cladding section has the second softening temperature lower than the first softening temperature of the first glass configuring the core.

### BRIEF DESCRIPTION OF THE DRAWINGS

FIG. 1 is a cross-sectional view of a preform according to an embodiment of the present invention.

FIG. 2 is a cross-sectional view of a core of an optical fiber obtained by drawing a preform in a first comparative example.

FIG. 3 is a cross-sectional view of a preform manufactured in a second example of the present invention.

FIG. 4 is a cross-sectional view of a preform manufactured in a third example of the present invention.

### BEST MODES FOR CARRYING OUT THE INVENTION

An optical fiber preform according to a preferred embodiment of the present invention includes a core having a polygonal shape, for example, in the cross-section thereof, and is thus different from a conventional preform including an axisymmetric core. An optical fiber manufactured from the optical fiber preform of the preferred embodiment includes a core having a polygonal shape as well in the cross-section thereof. The optical fiber thus manufactured may preferably be used for direct transmission of a photographic image having a polygonal shape, for example.

Moreover, the configuration wherein the softening temperature of a first glass, such as a core section, having an arbitrary shape is higher than the softening temperature of a second glass, such as a cladding section, covering the outer periphery of the first glass provides an optical fiber having an arbitrary shape with a higher accuracy.

In an optical fiber having an arbitrary shape, the core section or stress-applying section having the arbitrary shape is doped with a dopant, such as germanium, boron and fluorine, and has a softening temperature lower than the softening temperature of the glass member covering the core section or stress-applying section.

A method for manufacturing an optical fiber according to a preferred embodiment of the present invention includes the step of covering the outer periphery of the first glass having a polygonal shape, for example, with the second glass having a softening temperature lower the softening temperature of the first glass, heating first and second glasses up to a heating temperature for fusion, thereby forming a preform of an integral body of first and second glasses, and drawing the preform to the optical fiber.

First, the second glass fuses and adheres onto the first glass by heating.

The heating temperature at which the second glass is fused is set below the softening temperature of the first glass, whereby the first glass maintains the original polygonal shape in the cross-section thereof. This achieves a higher accuracy of the polygonal shape of the first glass, thereby providing an optical fiber having a desired polygonal shape with a higher accuracy.

A glass tube may be used as an outer member for the second glass member. In this case, the first and second glasses are arranged or assembled within the glass tube, and are heated. This prevents deformation from the polygonal shape to obtain a preform having a desired shape. In case the glass tube attached outside the second glass configuring a cladding, the glass tube is configured as a part of the cladding after drawing the preform to an optical fiber. Use of the glass tube allows the cladding shape to be maintained with ease. The softening temperature of the glass tube is preferably higher than the softening temperature of the second glass, and may be preferably equal to the softening temperature of the first glass.

### EXAMPLES

### First Example

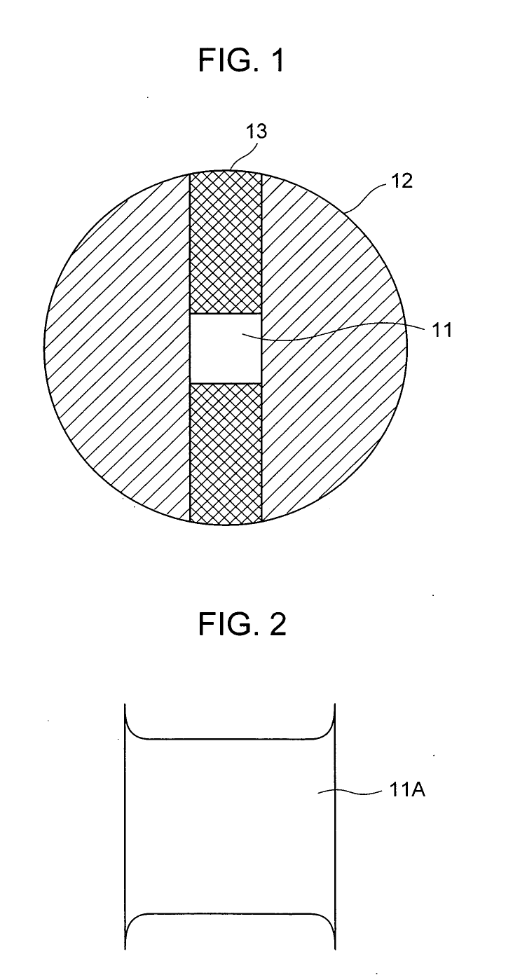

FIG. 1 shows a cross-sectional view of a preform according to a first example of the present invention. Glass members 11, 12 and 13 having the shape as shown in FIG. 1 were obtained by grinding glass materials, and were assembled and fused together to form an optical fiber preform. The glass member 11 had a shape of a pole having a square cross-section, and a pair of glass members 13 each had a shape of a pole having a rectangular cross-section, wherein one of the shorter sides of the rectangle configured a circular arc, which formed a part of the cylindrical surface of the cladding. A pair of glass members 12 each had a substantially half-cylindrical surface, which was assembled with the circular arc of the glass members 13 so that a substantially complete cylindrical surface was formed from the glass members 12 and 13. These glass members 11, 12 and 13 were assembled together such that the glass members 13 were disposed first so as to oppose each other, with the glass member 11 being sandwiched therebetween, and the glass members 12 were then disposed, with the flat surface of the glass members 12 abutting to the flat surface of the glass members 11 and 13. The resultant preform had a shape of a cylinder.

The glass member 11 was made of a material having a softening temperature higher than the softening temperature of the glass members 12 and 13, and thus was not liable to deformation at a heating temperature lower the softening temperature thereof. As a concrete example, the glass member 11 was made of pure quartz, whereas the glass members 12 and 13 were made of quartz doped with fluorine. In general, the glass material is easily deformed at a temperature exceeding the softening temperature thereof. The glass member 11 had a softening temperature of 1800 degrees C., whereas the glass members 12 and 13 had a softening temperature of 1600 degrees C. due to doping the quartz with 2 wt.-percent fluorine. Those glass members 11, 12 and 13 were assembled together, as shown in FIG. 1, and fused together by heating in an electric furnace. A specific case of fusing together these members at a temperature of 1650 degrees C. provided an optimum cross-sectional shape having a least deformation.

In the process of the present embodiment, an electric furnace was used for fusing, but not limited thereto. A burner providing a flame may be used for this purpose so long as the burner provides a uniform temperature distribution during the fusion coupling of the glass members. The softening temperature, 1650 degrees C., is only an example, and a softening temperature in a range between the softening temperatures of both the glass materials may be used instead. An excessively lower temperature dose not provide a suitable fusion and a peeling-off may occur. On the other hand, an excessively higher temperature involves a larger deformation. Thus, it is preferable that a temperature about 50 degrees C. higher than the lower softening temperature be used for the fusing.

The preform as described above is drawn to an optical fiber in a drawing furnace at a temperature of 1820 degrees C. The resultant optical fiber had no substantial deformation in the core. In general, a core having a square cross-section, such as shown in FIG. 1, as well as another core having a polygonal cross-section may be evaluated for the degree of deformation thereof by expressing the vertex angle at each corner or apex of the cross-section. In the resultant optical fiber, the corner of the cross section of the core was maintained at a substantially right angle without incurring a problem in the deformation. In addition, the non-circularity of the cladding in the resultant optical fiber was as low as about 1.0%, without incurring a substantial problem in the circularity of the optical fiber.

### First Comparative Example

In a first comparative example of the preform having a structure similar to the structure shown in FIG. 1, the glass member 11 was made of quartz doped with germanium and the glass members 12 and 13 were made of pure quartz. In this structure, the first glass member 11 had a softening temperature of 1600 degrees C. whereas the glass members 12 and 13 had a softening temperature of 1800 degrees C. Fusing of these glass members 11, 12 and 13 was conducted at a temperature of 1650 degrees, which is 50 degrees C. higher than the softening temperature of the glass member 11. This provided a preform having a least deformation among other fusing processes for the same structure at different temperatures. The resultant preform was drawn to an optical fiber at a temperature of 1900 degrees C., which was about 80 degrees C. higher than the drawing temperature used in the first example.

FIG. 2 shows the cross-section of the core of the optical fiber obtained in the first comparative example. The core 11A obtained from the glass member 11 of the first comparative example had a significant deformation. The deformation was such that each of the corners of the core 11 in the preform was melted, flowed out into the gap between the glass member 12 and the glass member 13 configuring a part of the cladding, and solidified in the as-melted state within the gap. If the optical fiber obtained from this comparative example is used for direct transmission of a photographic image, the transmitted image will have a significant deformation whereby the optical fiber does not achieve the object of the present invention. The optical fiber obtained in the first comparative example had a non-circularity of 0.9% which was comparable to the non-circularity obtained in the first example of the present invention.

### Second Example

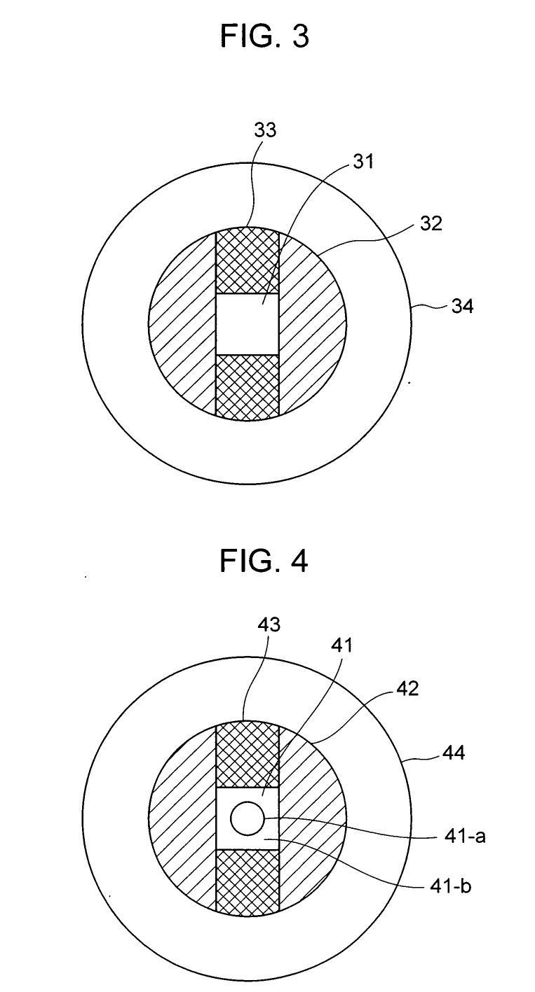

FIG. 3 shows a preform according to a second example of the present invention. Glass members 31 to 33 were similar to the glass members 11 to 13 shown in FIG. 1. Another glass member 34 is a glass tube made of a material similar to the material of the glass member 31 (11). The glass members 31 to 33 were assembled together and inserted into the glass member 34. More precisely, the glass members of the present example had a dimensional ratio different from the dimensional ratio of the glass members 11 to 13 in the first example, for achieving the final diameter of the core that is comparable to the final diameter of the core in the first example. This was achieved by the configuration wherein the dimensions of the glass member 31 were equal to the dimensions of the glass member 11, and the outer diameter of the glass member 34 was equal to the outer diameter of the preform shown in FIG. 1.

After assembling the glass members 31 to 34 in the structure as shown in FIG. 3, the assembly of glass members 31 to 34 was drawn to an optical fiber at a temperature similar to the temperature used in the first example. The resultant optical fiber had a deformation in the core comparable to the deformation in the first example; however, the non-circularity of the cladding was 0.2% which was superior to that of the first example. Comparison of the structure obtained by inserting the glass members 31 to 33 assembled and fused beforehand into the glass tube 34 against the structure obtained by inserting the as-assembled glass members 31 to 33 into the glass tube 34 did not provide a significant difference after drawing to the optical fiber.

The core used in the above examples had a square cross-section; however, the core may have any contour such as polygon or star shape for achieving a similar result, which was confirmed in other experiments.

### Third Example

FIG. 4 shows a preform according to a third example. The glass members 42 to 44 in FIG. 4 are similar to glass members 32 to 34 shown in FIG. 3. The glass member 41a is of a cylinder inserted in the glass member 41b having a square cross-section in the outline. The glass member 41a has a softening temperature lower than the softening temperature of the glass member 41b, which is higher than the softening temperature of the other glass members 42 to 44. This configuration achieves a drawing process incurring substantially no deformation.

After assembling the glass members 41 to 44 in the structure as shown in FIG. 4, the assembly of glass members 41 to 44 was drawn to an optical fiber at a temperature similar to the temperature used in the first example. The relationship in the softening temperature between the glass member 41a and the glass member 41b is similar to the relationship in the normal optical fiber. That is, the glass member 41a has a softening temperature lower than the softening temperature of the glass member 41b. In this structure, the axial symmetry of the glass member 41a provided substantially no deformation in the glass members 41a and 41b after drawing to an optical fiber.

Samples having a structure of the first example and a softening temperature of 1700 degrees C. in the glass members 12 and 13 were prepared, and subjected to a fusing process at temperatures between 1700 degrees C. and 1800 degrees C. A softening temperature of the glass members 11 is 1800 degrees C. Results of the structure with respect to the core deformation and degree of fusion of the glass members after the fusing process are shown in the following table 1.

TABLE 1

| Heating Temp. | Softening Temp. | Fusion | Deformation of Core |
|---|---|---|---|
| 1800 | 1700 | G | NG |
| 1790 | 1700 | G | NG |
| 1780 | 1700 | G | NG |
| 1770 | 1700 | G | NG |
| 1760 | 1700 | G | NG |
| 1750 | 1700 | G | G |
| 1740 | 1700 | NG | — |
| 1730 | 1700 | NG | — |
| 1720 | 1700 | NG | — |
| 1710 | 1700 | NG | — |
| 1700 | 1700 | NG | — |

In the table 1, “G” indicates Good, “NG” indicates No Good, and “--” indicates not measurable. In the above results, the fusion itself was achieved without a problem so long as the heating temperature was higher than the softening temperature of the glass members 12 and 13 by 50 degrees C. or higher. However, a heating temperature of 1760 degrees C. or higher resulted in deformation of the core. For the purpose of fusing, the viscosity of the core glass should be lowered to some extent. That is, a temperature 50 degrees C. lower than the softening temperature of the glass member 11, at which the glass member is on the verge of melting, is most suitable in the view point of prevention of deformation.

Table 2 shows heating temperatures dependency of the deformation of core for the glass members 12 and 13 having softening temperatures between 1600 degrees C. and 1720 degrees C. A softening temperature of the glass members 11 is 1800 degrees C.

TABLE 2

| Heating Temp. | Softening Temp. | Fusion | Deformation of Core |
|---|---|---|---|
| 1750 | 1720 | NG | — |
| 1750 | 1710 | NG | — |
| 1750 | 1700 | G | G |
| 1750 | 1690 | G | G |
| 1750 | 1680 | G | G |
| 1750 | 1670 | G | G |
| 1750 | 1660 | G | G |
| 1750 | 1650 | G | G |
| 1750 | 1600 | G | G |
| 1740 | 1600 | G | G |
| 1730 | 1600 | G | G |
| 1720 | 1600 | G | G |
| 1710 | 1600 | G | G |
| 1700 | 1600 | G | G |
| 1690 | 1600 | G | G |
| 1680 | 1600 | G | G |
| 1670 | 1600 | G | G |
| 1660 | 1600 | G | G |
| 1650 | 1600 | G | G |
| 1640 | 1600 | NG | — |

In the table 2, “G” indicates Good, “NG” indicates No Good, and “--” indicates not measurable. A heating temperature less than 50 degrees C. higher than the softening temperature of the glass members 12 and 13 achieved insufficient fusion whereby a suitable preform was not formed. On the other hand, a temperature 50 degrees or above higher than the softening temperature of the glass members 12 and 13 achieved a suitable fusion without a problem. In these experiments, since the heating temperature was set at 1750 degrees C. or lower, which is 50 degrees C. lower than the softening temperature of the glass members 11, in consideration of the results shown in FIG. 1, all the samples that achieved a suitable fusion exhibited no significant deformation.

In addition, although not shown in Table 2, a lower heating temperature provides a lower degree of deformation of the core, and thus should be employed so long as fusion itself is achieved. This means a heating temperature 50 degrees C. higher than the softening temperature of the glass members 12 and 13 is optimum. Drawing of all the preforms manufactured in these experiments provided optical fibers having a degree of deformation of the core and non-circularity of the cladding comparable to those achieved in the first example.

From the above results, the heating temperature for fusion coupling should be preferably 50 degrees C. or above higher than the softening temperature of the glass members 12 and 13, and also 50 degrees C. or above lower than the softening temperature of the glass member 11. Thus, the softening temperature of the glass members 12 and 13 should preferably be 100 degrees C. or above lower than the softening temperature of the glass member 11.

Since the above embodiment and examples are described only for exemplification purposes, the present invention is not limited to the above embodiment or examples and various modifications or alterations can be easily made therefrom by those skilled in the art without departing from the scope of the present invention.

1. A method for manufacturing a preform comprising the steps of:
covering an outer periphery of a first glass (11) having a single first softening temperature by a second glass (12, 13) having a single second softening temperature which is lower than said first softening temperature; and
heating said first and second glasses (11, 12, 13) up to a heating temperature for fusion, thereby forming an integral body of said first and second glasses.

2. The method according to claim 1, wherein said second glass includes at least two glass members (12, 13) assembled.

3. The method according to claim 1, wherein said second softening temperature is 100 degrees C. or above lower than said first softening temperature.

4. The method according to claim 1, wherein said heating temperature is 50 degrees C. or above higher than said second softening temperature, and 50 degrees C. or above lower than said first softening temperature.

5. The method according to any one of claims 1 to 4, wherein said first glass has a non-axisymmetric structure.

6. The method according to any one of claims 1 to 5, wherein said first glass (11) configures a core section.

7. A method for manufacturing an optical fiber comprising the steps of:
covering an outer periphery of a first glass (31) having a single first softening temperature by a second glass (32, 33) having a single second softening temperature which is lower than said first softening temperature;
inserting an assembly of said first and second glasses (31, 32, 33) in a glass tube (34); and
collapsing said glass tube (34) and said assembly of said first and second glasses (31, 32, 33) by heating at the same time of drawing the optical fiber.

8. The method according to claim 7, wherein said first glass (31) has a non-axisymmetric structure.

9. The method according to claim 7 or 8, wherein said first glass (31) configures a core section.

10. An optical fiber preform comprising a plurality of glasses including first and second glasses (11, 12, 13), wherein said first glass (11) configures a central core section and has a non-axisymmetric structure, said second glass (12, 13) configures a cladding section covering an outer periphery of said first glass (11), and said first glass (11) has a softening temperature higher than a softening temperature of said second glass (12, 13).

11. The optical fiber preform according to claim 10, wherein said first glass (11) has a polygonal cross-section.

12. An optical fiber manufactured by drawing the optical fiber preform according to claim 10 or 11.
